(19) United States
(12) Patent Application Publication
(10) Pub. No.: US 2026/0165245 A1
(43) Pub. Date: Jun. 18, 2026

(54) PNEUMATIC COTTON HARVESTING MACHINE WITH VACUUM CHAMBER PICKING HEADS AND METHOD EMPLOYED THEREOF

(71) Applicant: VENKATA NARSIMHA REDDY NALAMALA, HYDERBAD (IN)

(72) Inventor: VENKATA NARSIMHA REDDY NALAMALA, HYDERBAD (IN)

(21) Appl. No.: 19/247,159

(22) Filed: Jun. 24, 2025

(51) Int. Cl. A01D 46/10; A01D 46/12

(52) U.S. Cl. CPC A01D 46/10; A01D 46/12

(57) ABSTRACT

Exemplary embodiments of the present disclosure are directed towards a pneumatic cotton harvesting machine equipped with vacuum chamber picking heads and method employed thereof. The machine comprising a chassis is configured to move the cotton harvesting machine along the cotton rows. One or more vacuum chamber picking heads with vacuum chambers integrated into the picking heads. The vacuum chamber picking head is configured to remove seed cotton from the bolls as this machine passes in front of the picking slots, the cotton is then transported through the vacuum chamber, with the picking head's height adjustable to maintain the required ground clearance, and the chassis allows for horizontal movement, facilitating self-alignment with cotton rows. A sealed cotton collecting bin fitted on the chassis, whereby the bin is configured to empty cotton by blowing forced air through the strainer, and it operates with a set of three-way valves, enabling the bin to be emptied.

### TECHNICAL FIELD

The provided document generally relates to agricultural cotton harvesting machinery. More particularly, the present disclosure relates to a pneumatic cotton harvesting machine equipped with vacuum chamber picking heads and method employed thereof.

### BACKGROUND

Cotton is a labor-intensive crop, and efforts to develop suitable machines for cotton harvesting in the United States have been ongoing since the 1850s. Over the years, numerous patents have been filed for devices featuring both mechanical and pneumatic picking heads for cotton harvesting. However, none of these designs proved commercially viable until the 1930s when the first successful mechanical cotton picker was developed. In the 1940s, the International Harvester Company and later John Deere introduced spindle-type picking head harvesters. During the same period, stripper-type design harvesters were also commercialized. These mechanical cotton harvesters have undergone several improvements over time. Today, cotton harvesting machines equipped with only mechanical picking heads are in use.

The limitations of conventional cotton harvesting methods are twofold. First, they suffer from insufficient collection speed and require significant manual labor. Second, mechanized harvesting methods, although more efficient, often lead to damage, such as tearing or twisting of cotton fibers, which degrades the quality of the harvested cotton. Additionally, these methods can harm the cotton bush and introduce impurities due to the damage caused during the picking process.

Although several pneumatic picking devices, with “air-blast” and “vacuum” picking heads, were patented in the past century, they were not commercially successful due to lower picking efficiency compared to mechanical harvesters. In contrast, machines with stripper-type and spindle-type picking heads have proven commercially viable. Currently, 100% of cotton harvesting in major cotton-producing countries like the USA, Australia, and Brazil is done using these machines, which have been optimized through pre-cleaning processes, suitable seed varieties, and improved farming practices.

The conventional approach to utilizing vacuum air suction for cotton harvesting has some key drawbacks. The pneumatic cotton-picking machines developed till now relying on vacuum suction are non-selective, often picking up not only cotton but also sticks, leaves, dirt particles, and other debris. As a result, cotton harvested by these machines is often contaminated with dirt, lowering its quality. This contamination remains during the ginning process, and the dirty cotton is baled and sold in its current state. Additionally, these machines tend to drop around 10 to 20% of the cotton fiber on the ground during the picking process, further reducing harvest efficiency. Any cotton harvesting machine with less than 95% picking efficiency is not suitable for commercial use.

One picking head spindle of a multi spindle mechanical cotton harvesting machine contains more than 500 rotating picking spindles that rotate at 2000-3000 rpm. This results in high initial and maintenance costs. This along with the need for skilled operators and maintenance personnel, have prevented the widespread adoption of mechanical cotton harvesting machines in developing countries like India. As a result, 100% of cotton in these regions is still harvested manually. The migration of youth to urban areas has led to a severe shortage of labor in rural areas, which, combined with rising wages, threatens the sustainability of cotton farming in these regions.

In the light of aforementioned discussion, there exists a need for a pneumatic cotton harvesting machine with improved picking efficiency and reduced cost and method that would overcome or ameliorate the above-mentioned limitations.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a pneumatic cotton harvesting machine equipped with vacuum chamber picking heads and method employed thereof.

An objective of the present disclosure is directed towards to provide a cotton harvesting machine that is simple, cost-effective, and low-maintenance while offering improved efficiency and reduced operational costs.

Another objective of the present disclosure is directed towards to achieve nearly 100% cotton-picking efficiency through a high vacuum picking system, consisting of a vacuum picking chamber in the picking head, and seed cotton from the picking head is conveyed into a sealed collection bin via pneumatic pipes, with air being drawn through a filter mesh inside the collection bin into the vacuum blower's suction.

Another objective of the present disclosure is directed towards to eliminate the need for heating and the removal of water and oil, which are typically required by other cotton-picking machines with mechanical picking heads.

Another objective of the present disclosure is to ensure that the picking heads maintain the required ground clearance, even in fields with undulating terrain.

Another objective of the present disclosure is to incorporate a provision in the picking head attachment to the machine chassis that allows slight lateral movement, enabling the picking head to self-align with the cotton plant rows.

According to an exemplary embodiment of the present disclosure, a pneumatic cotton harvesting machine includes a chassis mounted on wheels, whereby the chassis is configured to move the cotton harvesting machine along the cotton rows.

According to an exemplary embodiment of the present disclosure, a pneumatic cotton harvesting machine further includes a power source is configured to provide power for driving the chassis over the cotton field.

According to an exemplary embodiment of the present disclosure, a pneumatic cotton harvesting machine further includes a vacuum blower mounted on the chassis and connected to one or more vacuum chambers in the cotton-picking heads through pneumatic lines, whereby the vacuum blower is configured to generate the required vacuum pressure and air flow.

According to an exemplary embodiment of the present disclosure, a pneumatic cotton harvesting machine further includes one or more vacuum chamber picking heads, which include a front cotton plant compacting end and a vacuum picking chamber, the chamber has a picking channel with vertically and horizontally lined flexible inserts and vertical vacuum picking slots on the sides.

According to an exemplary embodiment of the present disclosure, a pneumatic cotton harvesting machine further includes a vacuum chamber picking head that is configured to remove seed cotton from the bolls as the compacted plant it passes in front of the picking slots, the cotton is then transported in to the collection bin through the vacuum chamber suction lines, and the picking head is height adjustable to maintain the required ground clearance by means of height adjusting wheels, and the chassis allows for its horizontal movement, facilitating self-alignment with cotton rows.

According to an exemplary embodiment of the present disclosure, a pneumatic cotton harvesting machine further includes a bunch of pneumatic lines connected to a manifold, facilitating the connection of the one or more vacuum chamber picking heads and these lines transport the picked cotton into a collection bin while air is drawn through a filter mesh at the vacuum blower's suction side, and the blower's outlet vents air to the atmosphere.

According to an exemplary embodiment of the present disclosure, a pneumatic cotton harvesting machine further includes a cotton collection bin fitted on the chassis, equipped with a built-in strainer, whereby the cotton collection bin is configured to empty cotton by blowing forced air through the strainer, and it operates with a set of three-way valves, enabling the cotton in the bin to be emptied.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. Only one vacuum chamber picking head is chosen for detailing and multiple picking heads will have similar construction and functioning. The level of detail associated with each of the elements or features should not be construed to qualify the novelty or importance of one feature over the others.

FIG. 1A is a top view of the pneumatic cotton harvesting machine equipped with vacuum chamber picking heads, according to exemplary embodiments of the present disclosure.

FIG. 1B is a left-side elevation of the cotton harvesting machine, according to exemplary embodiments of the present disclosure.

FIG. 1C is a side view of the vacuum chamber picking head as shown in FIG. 1B, according to exemplary embodiments of the present disclosure.

FIG. 1D is a front view “A” of the vacuum chamber picking head shown in FIG. 1C, and flexible inserts lining covering the cotton-picking channel in picking chamber, according to exemplary embodiments of the present disclosure.

FIG. 1E is shown without the flexible inserts lining covering the cotton-picking channel in picking chamber, according to exemplary embodiments of the present disclosure.

FIG. 1F is the top view “B” of the vacuum chamber picking head shown in FIG. 1C, according to exemplary embodiments of the present disclosure.

FIG. 1G is a view of the vacuum picking chamber of the picking head shown in FIG. 1C with wheel attachments removed for clarity, according to exemplary embodiments of the present disclosure.

FIG. 1H is the side view “M” of the vacuum picking chamber shown in FIG. 1G, according to exemplary embodiments of the present disclosure.

FIG. 1I is rear view “N” of the vacuum picking chamber shown in FIG. 1G and FIG. 1I is shown with flexible inserts lining covering the cotton-picking channel in picking chamber, while

FIG. 1J shows the same view without the flexible insert lining, according to exemplary embodiments of the present disclosure.

FIG. 1K is the sectional view along line X-Y of FIG. 1G showing the cotton-picking channel and cotton-picking slot within the vacuum chamber, in this view, FIG. 1K is shown with flexible inserts lining the cotton-picking channel, while FIG. 1L depicts the same view without the flexible insert lining, according to exemplary embodiments of the present disclosure.

FIG. 1M is the sectional view along line A-B of FIG. 1G, illustrating the movement of the picked cotton through the picking channel, picking slots, vacuum enclosures, and pneumatic manifold, according to exemplary embodiments of the present disclosure.

FIG. 1N is the sectional view along line C-D of FIG. 1H depicting vertical sides flexible inserts lining and bottom closure horizontal inserts lining in the cotton-picking channel, picking slots and vacuum enclosures, according to exemplary embodiments of the present disclosure.

FIG. 2 is a diagram depicting the pneumatic lay-out of the cotton harvester when in picking mode, according to exemplary embodiments of the present disclosure.

FIG. 3 is a diagram depicting the pneumatic lay-out of the cotton harvester while emptying the cotton from the storage bin, according to exemplary embodiments of the present disclosure.

FIG. 4 is a flow diagram depicting a method for harvesting cotton using a pneumatic cotton harvesting machine equipped with vacuum chamber picking heads, according to exemplary embodiments of the present disclosure.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

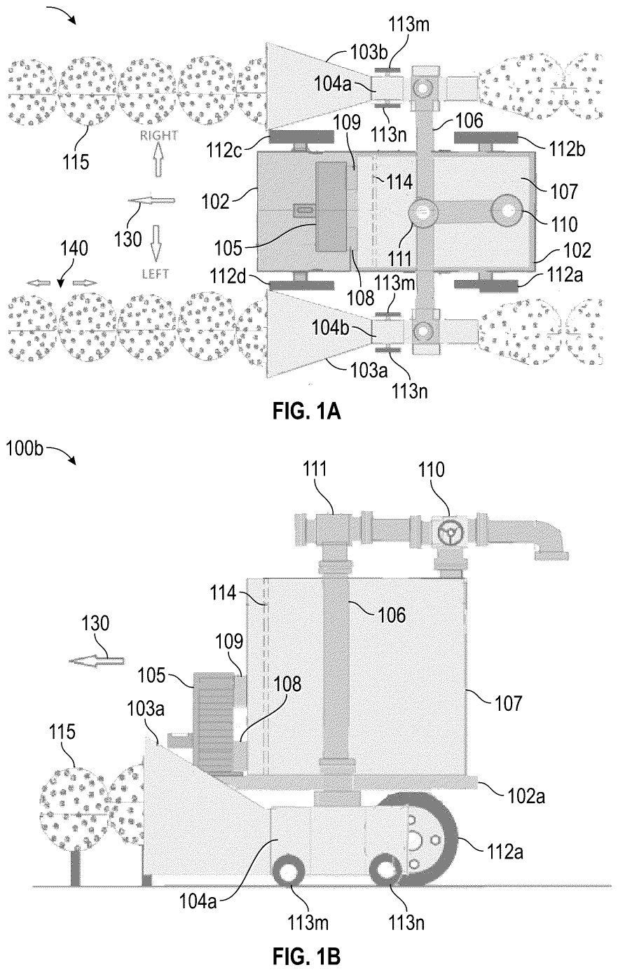

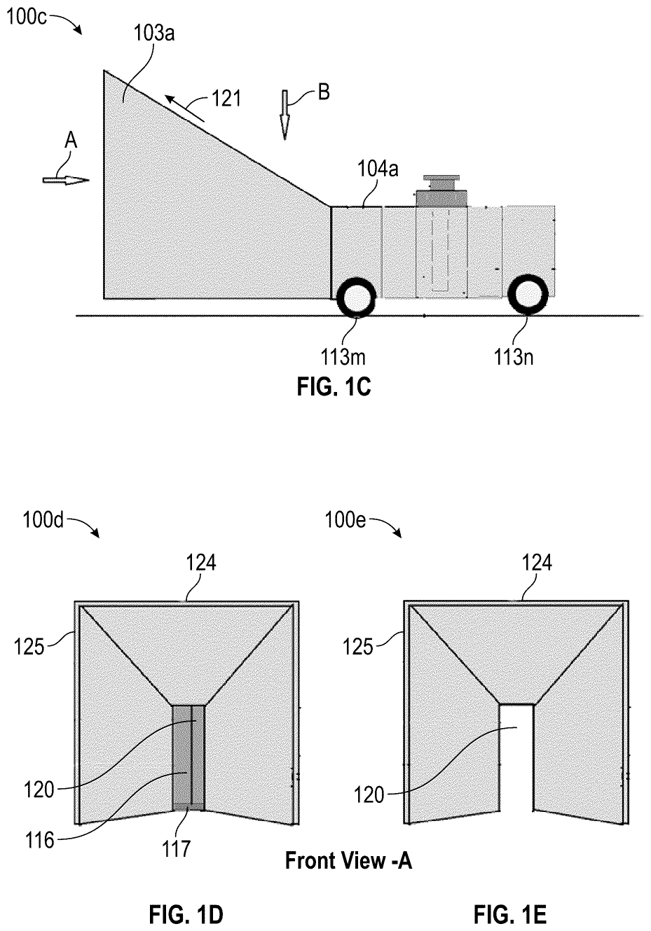

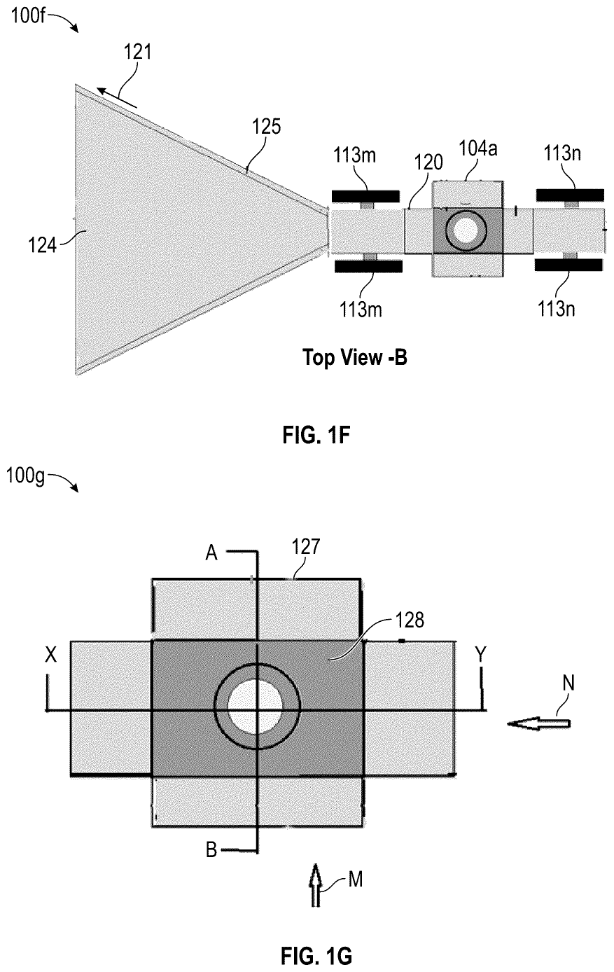

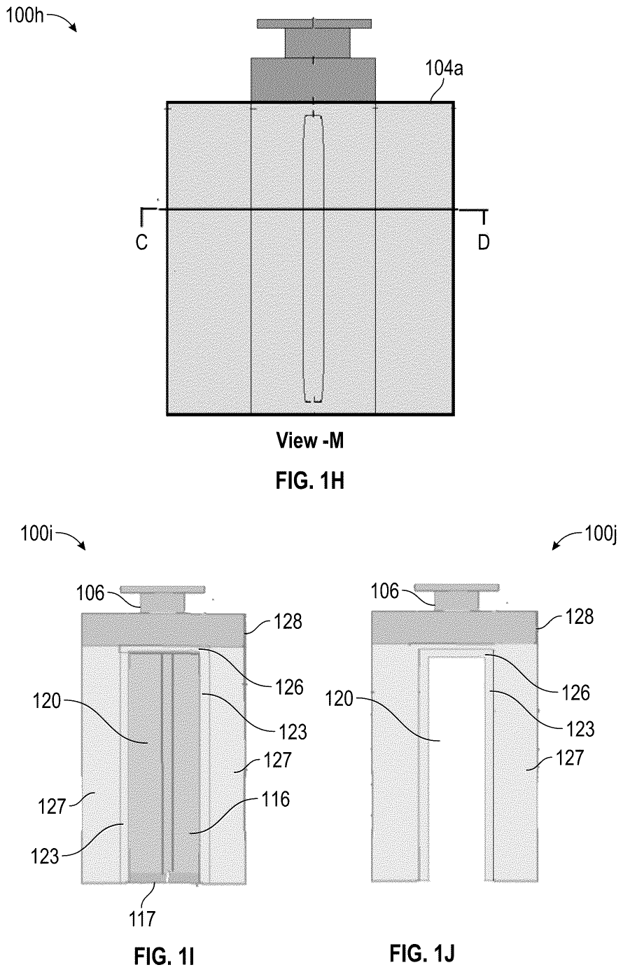

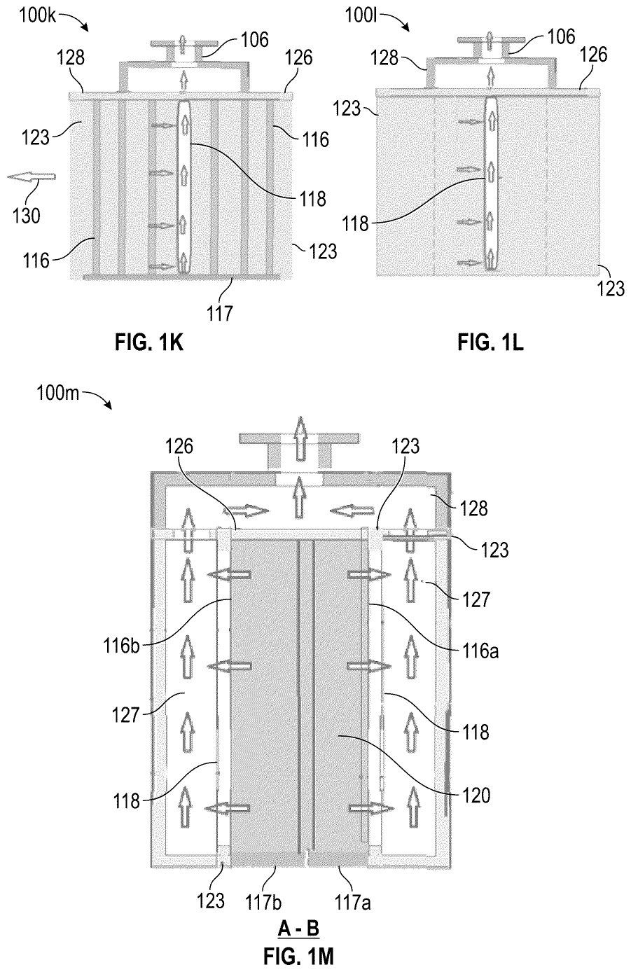

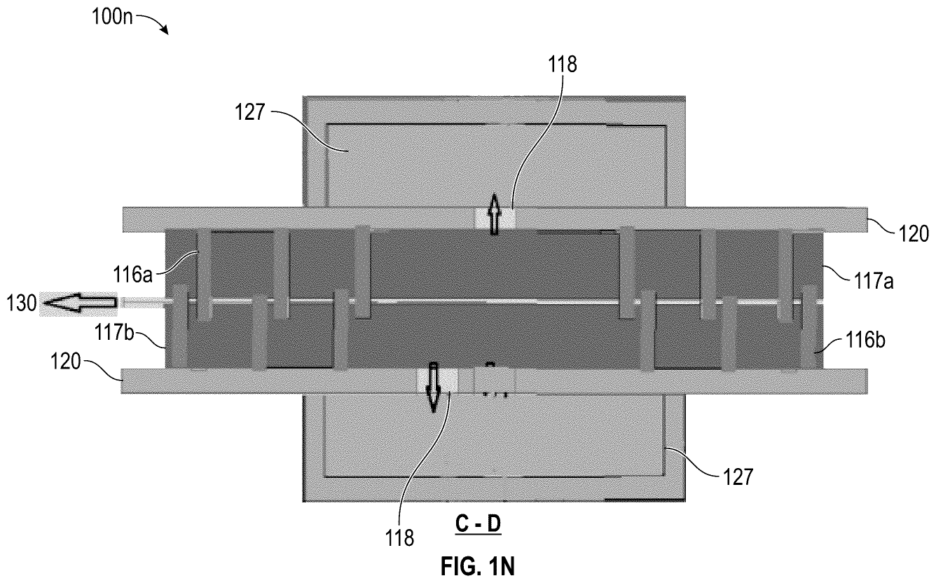

Referring to FIG. 1A is a top view 100a, FIG. 1B is a left-side view 100b, and FIG. 1C is a side view of the pneumatic cotton harvesting machines vacuum chamber picking head, according to exemplary embodiments of the present disclosure. The pneumatic cotton harvesting machine 100a includes a chassis 102, multiple vacuum chamber picking heads 103a-103b, consisting of inbuilt vacuum chambers 104a-104b, a vacuum blower 105, pneumatic lines 106, a sealed cotton collection bin 107, a set of three-way valves 108-110. The chassis 102 of the machine mounted on wheels 112a-112d. The chassis 102 is configured to move the cotton harvesting machine along the cotton rows 140. The chassis 102 further includes vacuum blower 105, with the capacity and number of blowers corresponding to the number of cotton-picking heads 103a-103b mounted on the machine. The multiple Picking heads 103a-103b are attached to the cotton harvester of the chassis 102. A power source is configured to provide power for driving the chassis over the cotton field 115. The machine may be tractor-drawn, self-propelled, or pushed by a farm vehicle, and the vacuum blower is powered by a gasoline engine or the tractor's PTO (Power Take-Off). The vacuum blower 105 mounted on the chassis 102 and connected to multiple vacuums picking chambers 104a-104b in the cotton-picking heads 103a-103b through pneumatic lines 106. The vacuum blower 105 is configured to generate the required vacuum pressure and air flow.

As shown in FIG. 1A-F IG. 1C, the multiple vacuum chambers 104a-104b integrated into the cotton-picking heads 103a-103b, and which includes a front cotton plant compacting end and a rear vacuum picking chamber. The vacuum chamber 104a has a picking channel with vertically and horizontally lined flexible inserts and vertical vacuum picking slots on the sides. The vacuum chamber picking head 103a is configured to remove seed cotton from the bolls as it passes in front of the picking slots, the cotton is then transported through the vacuum chamber 104 a. The picking head's height adjustable with wheels 113m to maintain the required ground clearance, and the chassis 102 allows for horizontal movement, facilitating self-alignment with cotton rows 140. The vacuum picking slots are not limited to two, and may be of multiple shapes, such as square, rectangular, circular, or any other configuration.

As shown in FIG. 1A-F IG. 1B, the bunch of pneumatic lines 106 connected to a manifold 128, facilitating the connection of the vacuum chambers 104a-104b of picking heads 103a-103b and these pneumatic lines 106 transport the picked cotton into the sealed cotton collection bin 107 while air is drawn through a filter mesh 114 at the vacuum blower's suction side, and the blower's outlet vents air to the atmosphere. The picking heads 103a-103b are attached to the cotton harvester chassis 102, with its each vacuum chamber 104a-104b connected to sealed collection bin 107 through pneumatic line 106 via a pneumatic manifold 128. The vacuum picking heads 103a-103b may be mounted on both the front and rear sides of the machine, and any number of picking heads may be mounted on a single chassis using blowers of appropriate capacity.

As shown in FIG. 1A, FIG. 1B, the sealed cotton collection bin 107 fitted on the chassis 102, equipped with a built-in strainer, The sealed cotton collection bin 107 is configured to empty cotton by blowing forced air from the blower 105 through the strainer, and it operates with the set of three-way valves 108-110, enabling the bin to be emptied. The valve 111 is connected to the vacuum picking heads 103a-103b. The valve 111 is a mechanical device that controls, directs, or regulates the flow air by opening, closing, or partially obstructing a passageway.

As shown in FIG. 1C, FIG. 1D, and FIG. 1N The picking head 103a contains a tapering front end 121 that compacts the cotton plants 115 both horizontally and vertically as the harvester moves in the direction 130 and in the rear a vacuum picking chamber 104a. The picking chamber 104a contains a narrow cotton-picking channel 120 lined with flexible inserts 116, 117 that cover all three open sides of the picking channel 120. The flexible inserts yield to the passage of cotton plants passage while restricting the entry of air into the channel from the three open sides. The vacuum picking chamber 104a also contains vacuum enclosures 127 on both sides of the picking channel 120 that are connected to the vacuum manifold 128 on top.

Referring to FIG. 1D is a front view “A” 100d, of the vacuum chamber picking head shown in FIG. 1C, and flexible inserts lining covering the cotton-picking channel in picking chamber, according to exemplary embodiments of the present disclosure. The picking chamber 104a consists of a narrow cotton-picking channel 120, lined with flexible inserts 116-117 covering all three open sides of the channel. The spacing between the picking heads is aligned with the row spacing of the cotton plants. The front end 121 of the picking head 103a is composed of two vertical plates 125. FIG. 1E shows the same front view without the flexible insert linings covering the cotton-picking channel in the picking chamber.

Referring to FIG. 1F is the top view “B” 100f, of the vacuum chamber picking head shown in FIG. 1C, according to exemplary embodiments of the present disclosure. The picking chamber 104a consists of a narrow cotton-picking channel 120, lined with flexible inserts 116-117 as shown in FIG. 1D, covering all three open sides of the channel. The front end 121 of the picking head 103a is composed of two vertical plates 125. These vertical plates 125 compact the cotton plant 15 laterally, while a sloping top plate 124 compresses the plant's height. The height of the picking head 103a from the ground is adjustable using the height-adjusting wheels 113a-113n . Additionally, provisions are made in the attachment of the picking head 103a to the machine chassis 102 to allow lateral movement, enabling self-alignment with the cotton plant rows 140.

Referring to FIG. 1G is a view 100g, of the vacuum picking chamber 104 a of the picking head shown in FIG. 1C with wheel attachments removed for clarity, according to exemplary embodiments of the present disclosure. The restricted airflow within the chamber creates the necessary vacuum within the two vacuum enclosures 127 located on either side of the picking channel 120. These vacuum enclosures 127 are connected to the pneumatic line 106 via the pneumatic manifold 128. As the cotton plant moves past the picking slots 118 in the picking channel 120, the seed cotton is pulled from the bolls into the vacuum enclosure 127. The vertical and horizontal flexible inserts 116-117 in the picking channel 120 help establish the required vacuum pressure at the vacuum picking slots 118 and enclosures 127. FIG. 1H shows a side view (M) of the vacuum picking chamber as shown in FIG. 1G.

Referring to FIG. 1I is rear view “N” 100i, of the vacuum picking chamber shown in FIG. 1G and FIG. 1I is shown with flexible inserts lining covering the cotton-picking channel in picking chamber, while FIG. 1J shows the same view without the flexible insert lining, according to exemplary embodiments of the present disclosure. The restricted airflow within the vacuum enclosures 127 creates the necessary vacuum pressure. When the harvester's picking head 103a moves over a cotton plant row 140, the cotton plant 115 enters the tapered receiving end 121 of the picking head 103a, where it is compacted both laterally and vertically. The plant then moves into the narrow picking channel 120, which contains vertical vacuum picking slots 118 on either side of the plant. These slots are spaced in a staggered pattern so that one side of the cotton plant 115 is exposed to the left-side vacuum picking slot 118 first. After passing this slot, the other side of the plant is exposed to the vacuum slot 118 on the right side of the picking channel.

Referring to FIG. 1K is the sectional view 100k, along line X-Y of FIG. 1G and FIG. 1N is the sectional view 100n along line C-D of FIG. 1H showing the cotton-picking channel 120 with flexible insert linings 116,117 and cotton-picking slot 118 within the vacuum chamber, while FIG. 1L depicts the same view without the flexible insert lining, according to exemplary embodiments of the present disclosure. The vacuum enclosures are connected to pneumatic lines 106 through the pneumatic manifold 128. As the harvester's picking head 103a moves over a cotton plant row 140, the cotton plant 115 is compacted both laterally and vertically as it enters the narrow picking channel 120. The plant is then exposed to the vacuum picking slots 118, with one side of the plant being exposed to the left-side slot first, and the other side exposed to the right-side slot. Thus, the entire cotton plant passes through the vacuum picking slots 118.

As shown in FIG. 1K and FIG. 1N the seed cotton is pulled out from the bolls as it passes in front of the picking slots 118 in the picking channel 120 into the vacuum enclosures 127. The vertical and horizontal flexible inserts 116-117 in the picking channel 120 play a crucial role in creating the necessary vacuum pressure at the vacuum picking slots 118 and vacuum enclosures 127. This high vacuum pressure results in nearly 100% cotton-picking efficiency. The horizontal flexible inserts 117 installed at the bottom of the picking channel 120 prevent soil dust from entering the channel and mixing with the seed cotton. Additionally, they help restrict the amount of air entering the vacuum picking channel from the bottom. The picked cotton is then transported through the pneumatic manifold 128 into the sealed collection bin 107 via pneumatic pipes 106. The height of the picking head 103a is adjustable from the ground using the height-adjusting wheels 113a-113n, and lateral movement provisions are included to ensure the picking head self-aligns with the cotton plant rows 140. FIG. 1M shows a sectional view along line A-B of FIG. 1G, illustrating the movement of the picked cotton through the picking channel, picking slots, and vacuum enclosures.

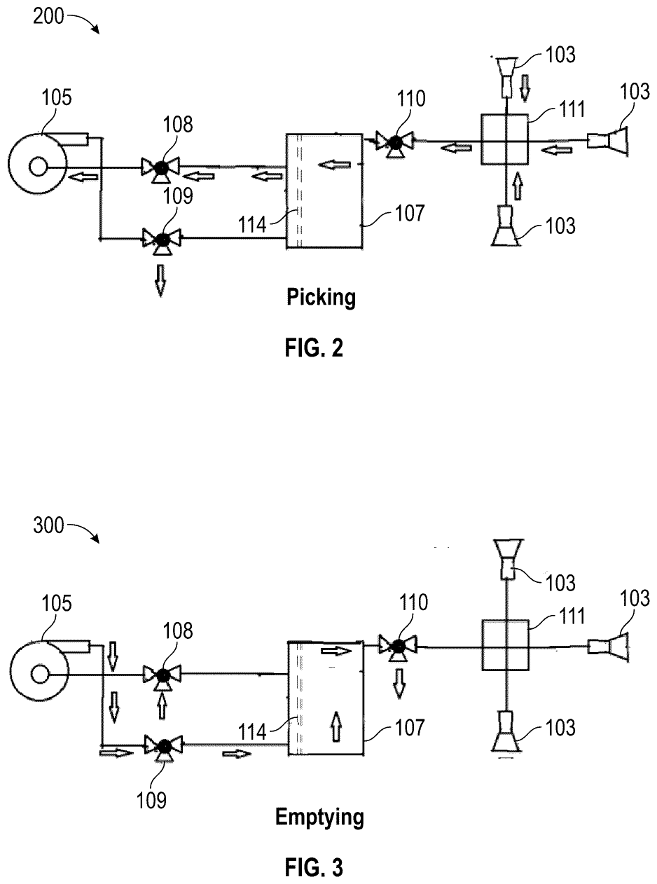

Referring to FIG. 2 is a diagram 200, depicting the pneumatic lay-out of the cotton harvester when in picking mode, according to exemplary embodiments of the present disclosure. The pneumatic cotton harvesting machine 100a includes a chassis 102, multiple picking heads 103a-103b, multiple vacuum chambers 104a-104b, a vacuum blower 105, pneumatic lines 106, sealed cotton collection bin 107, and a set of three-way valves 108-110. The sealed cotton collection bin 107 is fitted on the chassis 102 and equipped with a built-in strainer. The bin is configured to empty cotton by blowing forced air through the strainer. It operates with the set of three-way valves 108-110, allowing for both filling and emptying. Pneumatic lines 106 connected to a manifold 128 facilitate the connection of vacuum chambers 104a-104b and picking heads 103a-103b, transporting the picked cotton to the collection bin 107 while air is drawn through a filter mesh 114 at the vacuum blower's suction side. The blower vents the air to the atmosphere. FIG. 3 illustrates the pneumatic layout of the cotton harvester when emptying cotton from the storage bin.

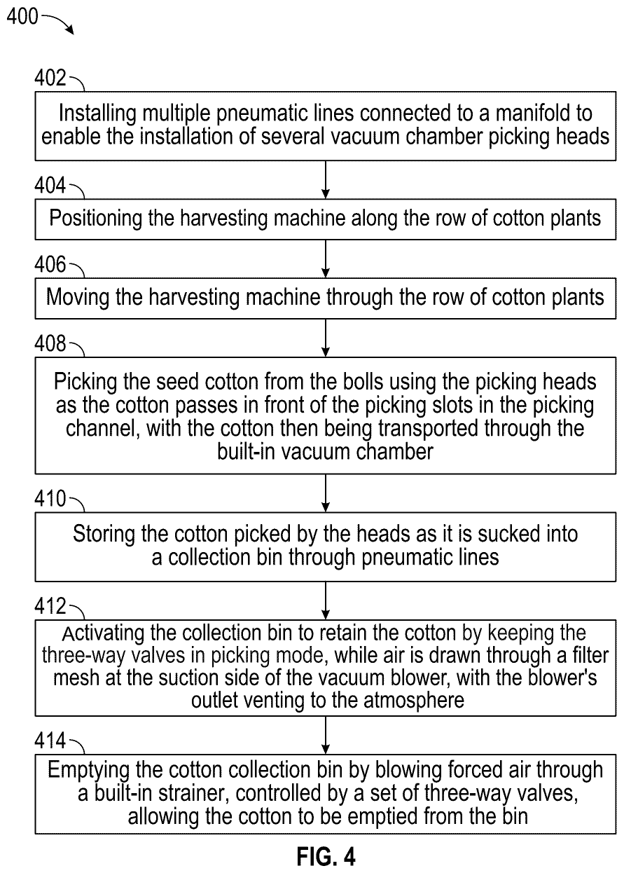

Referring to FIG. 4 is a flow diagram 400, depicting a method for harvesting cotton using a pneumatic cotton harvesting machine equipped with vacuum chamber picking heads, according to exemplary embodiments of the present disclosure. The method commences at step 402, installing multiple pneumatic lines connected to a manifold to enable the installation of several vacuum chamber picking heads. Thereafter at step 404, positioning the harvesting machine along the row of cotton plants. Thereafter at step 406, moving the harvesting machine through the row of cotton plants. Thereafter at step 408, picking the seed cotton from the bolls using the picking heads as the cotton passes in front of the picking slots in the picking channel, with the cotton then being transported through the built-in vacuum chamber.

As shown in FIG. 4, thereafter at step 410, storing the cotton picked by the heads as it is sucked into a collection bin through pneumatic lines. Thereafter at step 412, activating the collection bin to retain the cotton by keeping the three-way valves in picking mode, while air is drawn through a filter mesh at the suction side of the vacuum blower, with the blower's outlet venting to the atmosphere. Thereafter at step 414, emptying the cotton collection bin by blowing forced air through a built-in strainer, controlled by a set of three-way valves, allowing the cotton to be emptied from the bin.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

1. A pneumatic cotton harvesting machine, comprising:
a chassis mounted on wheels, whereby the chassis is configured to move the cotton harvesting machine along the cotton rows;
a power source is configured to provide power for driving the chassis over the cotton field;
a vacuum blower mounted on the chassis and connected to one or more vacuum chambers in the cotton-picking head through pneumatic lines, whereby the vacuum blower is configured to generate the required vacuum pressure and air flow;
one or more vacuum chamber picking heads with vacuum chambers integrated into the picking heads, which include a front cotton plant compacting end and a rear vacuum picking chamber, having a narrow picking channel with vertically and horizontally lined flexible inserts that allow passage of cotton plant through them but restrict the entry of air to create required vacuum and also having vertical vacuum picking slots on the sides;
a vacuum chamber picking head configured to remove seed cotton from the bolls as it passes in front of the picking slots, the cotton is then transported through the vacuum chamber, the picking head's height adjustable wheels maintain the required ground clearance, and the chassis allows for horizontal movement, facilitating self-alignment with cotton rows;
a bunch of pneumatic lines connected to a manifold, facilitating the connection of the one or more vacuum chamber picking heads and these lines transport the picked cotton into a collection bin while air is drawn through a filter mesh at the vacuum blower's suction side, and the blower's outlet vents air to the atmosphere; and
a sealed cotton collection bin fitted on the chassis, equipped with a built-in strainer, whereby the cotton collection bin is configured to empty cotton by blowing forced air through the strainer, and it operates with a set of three-way valves, enabling the bin to be emptied.

2. The pneumatic cotton harvesting machine as claimed in claim 1, wherein the chassis further includes one or more vacuum blowers, with the number of blowers corresponding to the number of cotton-picking heads mounted on the machine.

3. The pneumatic cotton harvesting machine as claimed in claim 1, wherein the machine can be tractor-drawn, self-propelled, or pushed by a farm vehicle, and the vacuum blower is powered by a gasoline engine or the tractor's PTO (Power Take-Off).

4. The pneumatic cotton harvesting machine as claimed in claim 1, wherein the one or more vacuum chamber picking heads are attached to the cotton harvester chassis, with each vacuum chamber connected to a pneumatic line via a pneumatic manifold.

5. The pneumatic cotton harvesting machine as claimed in claim 1, wherein the machine's picking head picks the seed cotton and limits the quantity of air entering the vacuum picking channel from the front and rear openings and from bottom with flexible inserts linings, and the seed cotton is then conveyed into a sealed collection bin through pneumatic pipes via the pneumatic manifold.

6. The pneumatic cotton harvesting machine as claimed in claim 1, wherein the vacuum picking heads may be mounted on both the front and rear sides of the machine, and any number of picking heads may be mounted on a single chassis using blowers of appropriate capacity.

7. The pneumatic cotton harvesting machine as claimed in claim 1, wherein the vacuum picking slots are not limited to two, and may be of multiple shapes, such as square, rectangular, circular, or any other configuration.

8. The pneumatic cotton harvesting machine as claimed in claim 1, wherein the picking chamber contains a narrow cotton-picking channel lined with flexible inserts that cover all three open sides of the channel, and the flexible inserts yield to the passage of cotton plants while restricting the entry of air into the channel from the three open sides.

9. The pneumatic cotton harvesting machine as claimed in claim 1, wherein the picking head includes a tapering front end that compacts the cotton plant both horizontally and vertically, and a vacuum picking chamber, and the flexible inserts linings that yield to the passage of cotton plants through them, restricting the entry of air into the picking channel.

10. A method for harvesting cotton using a pneumatic cotton harvesting machine equipped with a vacuum chamber and picking heads, comprising:
installing multiple pneumatic lines connected to a manifold to enable the installation of several vacuum chamber picking heads;
positioning the harvesting machine along the row of cotton plants:
moving the harvesting machine through the row of cotton plants;
picking the seed cotton from the bolls using the picking heads as the cotton passes in front of the picking slots in the picking channel, with the cotton then being transported through the built-in vacuum chamber;
storing the cotton picked by the heads as it is sucked into a collection bin through pneumatic lines;
activating the collection bin to retain the cotton by keeping the three-way valves in picking mode, while air is drawn through a filter mesh at the suction side of the vacuum blower, with the blower's outlet venting to the atmosphere; and
emptying the cotton collection bin by blowing forced air through a built-in strainer, controlled by a set of three-way valves, allowing the cotton to be emptied from the bin.
